(19) United States
(12) Patent Application Publication
(10) Pub. No.: US 2016/0219004 A1
(43) Pub. Date: Jul. 28, 2016

(54) AN APPARATUS AND METHOD FOR HANDLING METADATA OF AN EMAIL MESSAGE

(71) Applicant: GOLDMARK TECHNOLOGIES LTD, Rehovot (IL)

(72) Inventors: Johnathan EREZ, Rehovot (IL); Eduard NUDEL, Rehovot (IL)

(21) Appl. No.: 14/917,389

(22) PCT Filed: Aug. 11, 2014
(86) PCT No.: PCT/IL14/50720

§ 371 Date: Mar. 8, 2016

Related U.S. Application Data
(60) Provisional application No. 61/872,726, filed on Sep. 1, 2013.
(60) Provisional application No. 61/920,492, filed on Dec. 24, 2013.

(51) Int. Cl. H04L 12/58; G06F 17/22; G06F 3/0481; H04L 29/08

(52) U.S. Cl. CPC H04L 51/08; H04L 51/22; H04L 67/02; H04L 51/046; G06F 17/2235; G06F 3/04817

(57) ABSTRACT

A system and method for enriching a list of email message in an electronic device. The enrichment may be implemented by adding an image associated with a specific email message, for example extracted from an attachment or a link of the email message. The enrichment may also be implemented by adding metadata relevant to the email messages such as the number of recipients, number of attachments, number of links and enabling the user to perform an action on the email before opening it, such as perform a “like” on an image shown in the list of email messages.

### FIELD OF THE INVENTION

The present invention generally relates to extracting metadata and display images, more specifically to extraction of metadata and display of images from an email message.

### BACKGROUND OF THE INVENTION

Email messages are the most common manner of digital communication, with more than 180 billion email messages are sent each day, as of 2013. Email messages are more and more popular in the mobile devices, especially smartphones, as smartphone users enjoy the constant access to their email accounts, increase availability, service, efficiency and the like.

Smartphone users access their email accounts mainly via mobile applications, such as native email applications, or applications created by mail providers such as Google or Yahoo, or using 3^{rd} party applications that connects to existing or new mail providers and provide different design or functionality, such as Mailbox application. Those mobile applications are in fact a client side installed on the smartphone, in which the user can compose new messages, view incoming messages, and view a list of received messages, i.e. inbox level. The user can scroll inbox level when searching for a specific email message, while the email attributes displayed on the inbox level are usually the time in which the email was received, sender's name, subject of the email, number of messages in a specific conversation, read/unread notification, whether the email contains an attachment or not, body's preview (usually 1-2 lines from email's body).

However, those email attributes in the inbox level do not necessarily provide enough information in order to decide whether the email is important enough to be opened and read. Therefore most users need to spend a lot of time opening emails that may not necessarily be opened if the user had more relevant info in the first place.

### SUMMARY OF THE INVENTION

The present invention discloses a method and system for enriching a list of email messages viewed in an electronic device, such as a laptop, tablet or smartphone. Enrichment of the list of email messages may be implemented by adding an image to an email message of the list when appropriate, said image is associated with a link or an attachment of the specific email message. The image may be generated from a plurality of resources, such as an image extracted from a link, the title of the link and a logo of a web page from which the image was extracted. Enriching the list of email messages is also accomplished by adding metadata of the email messages in the list, also before the email messages are opened.

It is an object of the subject matter to disclose a method, comprising: receiving an email message of an email client; extracting email attributes from the email message; generating metadata that characterizes the received email message from the email attributes extracted from the email message; displaying the metadata that characterizes the received email message.

In some cases the metadata is displayed on an inbox level of the email client.

In some cases the metadata comprises number of total recipients of the email message and wherein said processing comprises accumulating the number of recipients of the email message and displaying the number of recipients on the inbox level of the email client. In some cases the metadata comprises number of attachment files attached to the received email message.

In some cases the metadata displayed on the inbox level of the email client also comprises an attachment type of the attachment files attached to the received email message. In some cases the metadata displayed on the inbox level of the email client also comprises the number of attachment files attached to the received email message. In some cases the metadata displayed on the inbox level of the email client also comprises a number of links found in the body of the received email message. Links associated with signatures may be filtered in order to provide only the number of links relevant to the content of the received email message. In some cases the metadata is displayed as an overlay on top of the email message on the inbox level of the email client. In some cases the metadata is displayed on a predefined area of the email on the inbox level of the email client.

In some cases the method comprises generating two or more metadata elements, each of the two or more metadata elements is associated with a different type of email attributes extracted from the received email, said two or more metadata elements are displayed on the inbox level of the email client.

In some cases the method comprises selecting whether or not to display the metadata for the received email message.

In some cases selecting whether or not to display the metadata is determined by comparing the extracted email attributes to a predefined condition.

In some cases the metadata indicates that the email client is the only email client of the email domain that receives the email.

In some cases the method is performed on a client side of the email client.

In some cases the metadata that characterizes the received email message is displayed as an image. In some cases the method further comprises selecting a specific image from an image storage according to the metadata. In some cases the metadata indicates a country of a sender of the received email message.

In some cases the email message comprises a link to a web page, wherein the extracted metadata comprises an indication of the source web page.

Other metadata displayed on the list of email messages may be metadata from images, posts or other items of a social network feed, such as number of likes, comments and shares of such item, name of the person who uploaded the image to the social network. Another metadata may be associated with an urgency indication of the body of the email, as elaborated below. Other metadata may be extracted from a link, such as a header of an article, caption of an image, text associated with an image, and the like.

It is another object of the subject matter to disclose a system, comprising: an email receiver for receiving an email message of an email client; attributes extraction unit for extracting email attributes from the email message; metadata processing unit generating metadata that characterizes the received email message from the email attributes extracted from the email message; wherein the generated metadata is displayed on a display device to characterize the received email message.

### BRIEF DESCRIPTION OF THE FIGURES

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1A shows a display of an inbox level, according to exemplary embodiments of the subject matter;

FIG. 1B shows a display of a single email message, according to exemplary embodiments of the subject matter;

FIG. 2 shows a system for processing an email messages, according to exemplary embodiments of the subject matter;

FIG. 3 shows a method for processing an email messages, according to exemplary embodiments of the subject matter;

FIG. 4 shows a list of email messages displayed on an email client, according to exemplary embodiments of the subject matter;

FIG. 5 shows extraction of metadata from the email and displaying the metadata of the email on the list of emails, without accessing the email itself, according to exemplary embodiments of the subject matter;

FIG. 6 shows a list of email from which the user of the email client can perform an action without accessing the email, according to exemplary embodiments of the subject matter;

FIG. 7 shows an exemplary embodiment in which advertisement is added into the list of email messages, according to exemplary embodiments of the subject matter;

FIG. 8 shows a method for extracting data associated to a specific email message and displaying the data, according to exemplary embodiments of the subject matter;

FIG. 9 shows a computerized environment for extracting data associated to a specific email message and displaying the data, according to exemplary embodiments of the subject matter.

### DETAILED DESCRIPTION

The present invention discloses a method and system for providing a user of an email application, whether provided as mobile application, web application, or web view only (where users enter specific URL to access their email account) with additional metadata characterizing a received email client. While user's existing solutions that receive standard email attributes as disclosed above are limited in the data and information provided to the user, the present invention processes the email attributes and generates new metadata regarding email's message and eventually help the user to resolve whether the email message is important enough to be opened and read. Such metadata can be displayed in the inbox level, i.e. list of emails, or when reading a specific email.

The metadata that characterizes the email message may be the total number of recipients of the email message. Another type of metadata may indicate whether the recipient is in the “TO” field or in the “CC” field in an email message. The total number of recipients may influence the user's perception on the received email, combined with known attributes of the received email. For example, in case the user received an email from his organization's CEO, the urgency in reviewing the email changes if the number of total recipients is 3, which requires urgent attention by the receiver, or more than 200 recipients, which may indicate a holiday greeting. Other metadata elements are detailed below.

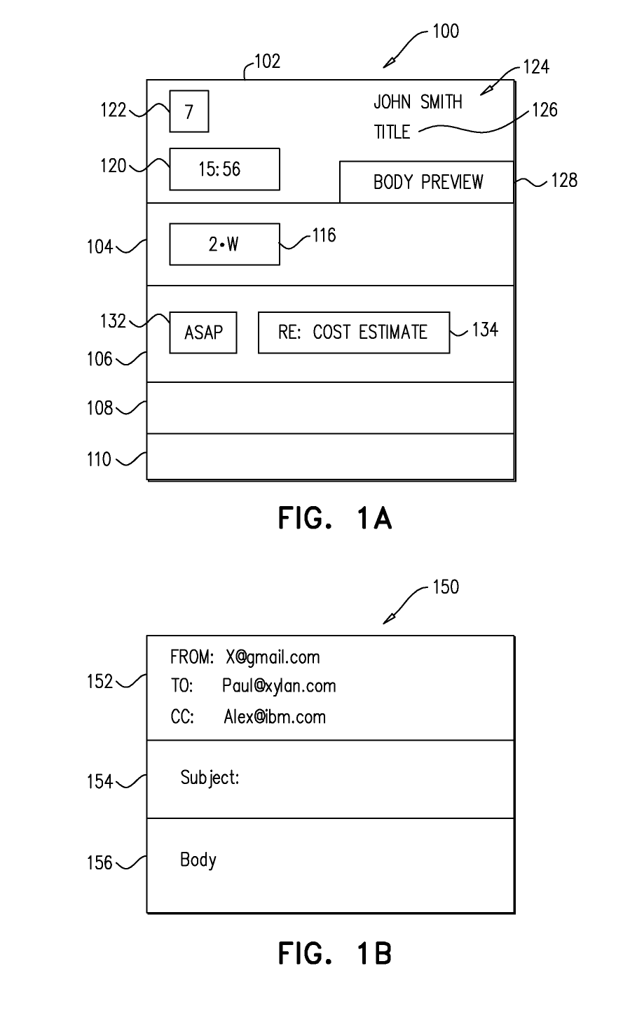

FIG. 1A shows a display of an inbox level, according to exemplary embodiments of the subject matter. The inbox level 100 displays two or more email messages and enables the user of the email mobile application to scroll upwards and downwards to review headers of a variety of email messages at the same screen. The inbox level displays an inbox level display of email messages 102, 104, 106, 108 and 110. The inbox level display of the email message 102 comprises an email's timestamp 120 of the email message, sender's name or address 124, the email message title 126, preview of the body 128 of the received email message 102. The inbox level display of the email message 102 also comprises a number of total recipients 122 of the email message 102, in this case seven (7) recipients. The location of the indication regarding the total number of recipients may be constant for all email messages, for example the top left corner of the email message. The indication regarding the total number of recipients may be displayed only in case there is more than one recipient to the received email message. In some cases, in which the email message is sent to an undisclosed group of recipients, an appropriate indication may be provided, for example “100+”.

The inbox level display of email message 104 refers to the attachment type and/or number of attachments of the email message 104. The email message 104 is provided with an attachment indication 116 which provides metadata on attachment files of the received email message 104. The attachment indication 116 may display only the total number of attachments, regardless its type, or display one icon per attachment file, for example display 3 icons of “w” in case the received email 104 comprises 3 word documents, or display a numeric indication next to the attachment type as an indication to the number of attachments from the same type. For example, the user waits for an email message from a specific sender that is to include an excel sheet. In case the user receives ten (10) email messages from the same sender, the inbox level display will facilitate the user in opening the most relevant email message first, the email message with an attachment indication of an excel sheet, without the necessity to open all the will not open all ten email messages before reaching the relevant email message.

The inbox level display of email message 106 refers to an urgency indication 132. Instead of composing a new email and flag it as important, an action that users rarely do when sending an important email, the system will analyze the text in each incoming email message and look for a predefined word or a set of words that represent urgency. For example, “asap”, “as soon as possible”, “urgent”, etc. Another example of a predefined word or a set of words that may indicate urgent email may contain the words “request for cost estimate” 134, “by the end of the day”, “your ticket is ready” or any other string that may require urgent action or notice from the user.

FIG. 1B shows a display of a single email message, according to exemplary embodiments of the subject matter. The single email message display 150 comprises a header 152. The header 152 contains the sender's name, recipients' names in the “to” field and recipients' names in the “cc” field. The single email message display 150 further comprises a subject which contains the subject field 154 of the email message. The single email message display 150 further comprises a body 156 which comprises the body of the message. In many cases, the metadata of the email message may also be displayed in the display of a single email message, after the received email message is opened by the recipient.

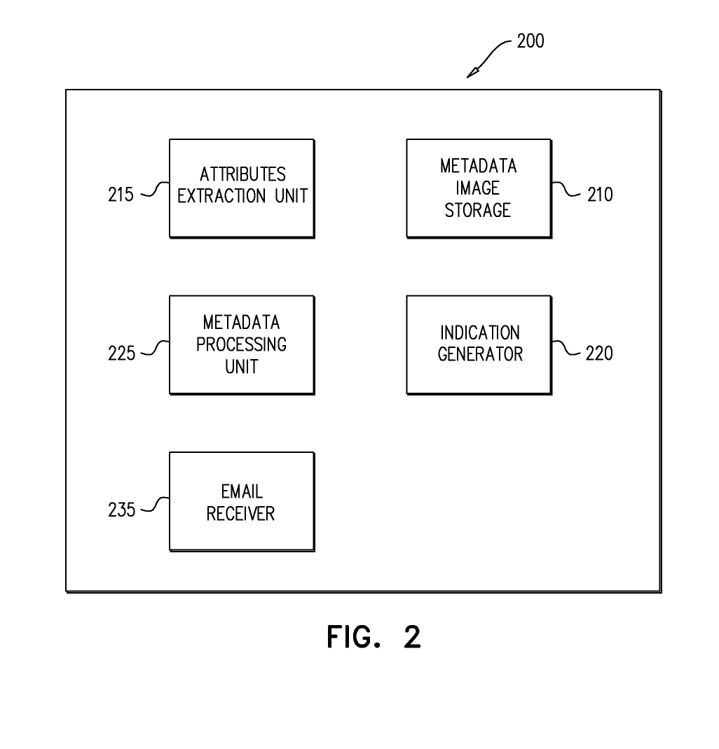

FIG. 2 shows a system for processing an email messages, according to exemplary embodiments of the subject matter. The system 200 comprises an email receiver 235 for receiving an email message. The email receiver 235 may reside at an email server or at an email client, such as at a mobile email application. The email message received at the email message comprises a body, subject, header attributes, such as sender's email address, various other email addresses of other recipients of the email message, attachments of the email and other email attributes.

The system 200 also comprises an attributes extraction unit 215 for extracting regular attributes from the received email message, this unit may reside at an email server or at an email client. The attributes extracted from the received email message may be other addresses that received the same email, attachments, title of the email message, and body of the email message, sender's name, sender's domain name and the like.

The system 200 also comprises a metadata processing unit 225 which may reside at an email server or at an email client. The metadata processing unit 225 analyzes the email attributes extracted by the attributes extraction unit 215 and processes additional metadata of the received email message. For example, the metadata processing unit 225 sums the number of email recipients to generate new metadata, the total number of recipients. The metadata processing unit 225 may also sum the number of attachments, define attachment type and the like. The metadata processing unit 225 generates an additional layer of content for the receiver, without the need of any action (like raising importance flag based on the analysis of the text inside the email) from the sender, from the data extracted from the email's attributes. Said metadata may later be displayed on the inbox level, displayed at the email level display or transmitted to a remote location for further processing. The metadata processing unit 225 may also determine an emergency or urgency indication, for example in case the received email message comprises a predefined term such as “as soon as possible” and the metadata processing unit 225 compares the body of the received email message to a list of predefined expressions. In other cases, an urgency indication may result when the user's email address is the only email address of the same domain in the received email, which is more relevant to business users. The user may also define other rules in which the urgency indication is displayed, for example every email message from a specific person that also includes a specific expression and received on Sundays. The urgency indication may be displayed at the inbox level or in the received email. Another example describes a situation where the sender sent an email late at night in his local time, a case that may suggest email's urgency.

The system 200 also comprises a metadata image storage 210 for storing images that represent the metadata generated for email messages received by the email receiver 235. The image storage may comprise images that represent indication for the importance of the received email, in case the received email contains a predefined word or term, such as “by the end of the day”. The image relevant to such term may be of a light bulb or another image representing emergency. Other images stored in the metadata image storage 210 may represent attachment types, people, and geographical indications such as flags or symbols of cities or known locations in cities. The images of the metadata image storage 210 may be displayed at the inbox level of the email client or inside the email itself, to enrich the user's experience.

The system 200 also comprises an indication generator 220 which may reside at an email server or at an email client, configured to generate indications concerning the received email message. The indication generator 220 may generate numerical indications, such as the total number of recipients or the total number of attachments in the email message. The indications may be of a predefined icon to be displayed adjacent to the numeric value, for example an icon representing persons will be displayed near the number of recipients, to indicate that the number represents the total number of recipients and not another metadata of the received email.

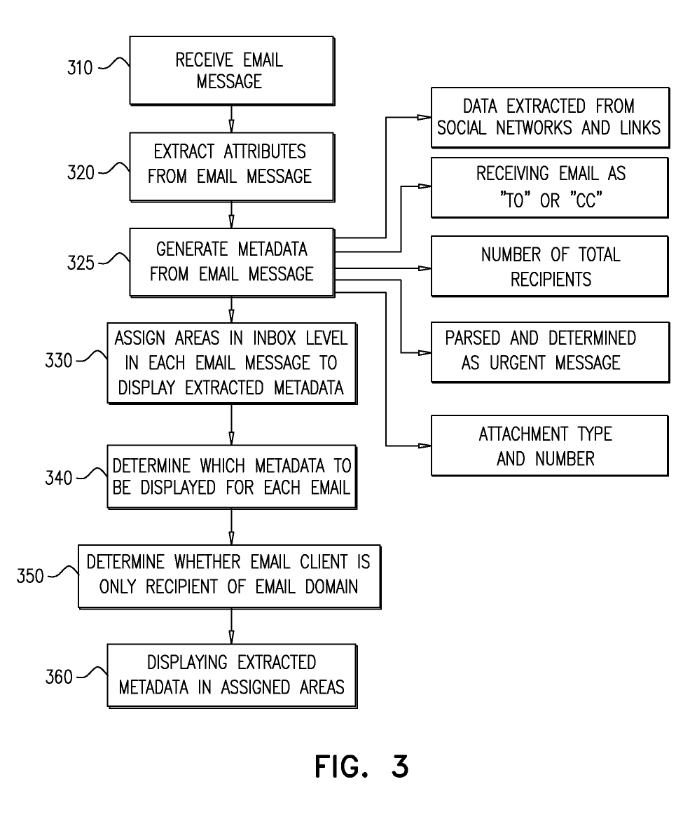

FIG. 3 shows a method for processing an email messages, according to exemplary embodiments of the subject matter. Step 310 discloses receiving an email message. Receiving the email message may be performed at an email server or at the email client, for example on a mobile device or a PC in which the email message is displayed. Step 320 discloses extracting attributes from the received email. Such attributes are a part of every email message, such as sender's name, sender's domain name, body of the email, email addresses of other recipients of the email, attachments of the email and the like. Step 325 discloses the analysis needed in order to generate the new metadata and generating the metadata itself for the specific received email message from the extracted email attributes. The metadata may be numeric, such as number of total recipients of the email. The metadata may be an urgency indication provided by performing text parsing on the email subject or body. The metadata may be a geographic indication on the sender of the email. The metadata may be type of attachments of the received email, or whether the receiver is in the “To” field or the “Cc” field.

In some exemplary cases, the metadata is an indication to the source of data inside the email in the form of a link/URL. For example, the received email message comprises a link. The system of the subject matter analyzes the link and the content in its destination and provides an indication related to the website the link has been generated from. The indication may be a logo of the website or the website's name or any other attribute located in the destination of the link (for example author name in case of the link to an article). For example, for a link that points to an article in CNN, the system will display the logo of CNN. Another example, if the link is a YouTube video, the system will display the logo of YouTube. In some cases, the system of the subject matter further comprises a list of links that may be stored in the system either at an email server or at an email client. This list contains hyperlinks of supported websites and images that represent website's logo. Each time an email contains a hyperlink, the hyperlink is being searched in the corresponded list. If there is a match, then website's logo is being displayed as an icon in the inbox level or in the email display, otherwise, no icon is being displayed.

In case an email message is received from Facebook or from another social network, the system of the subject matter may fetch metadata related to an image or a post which are a subject of the received email. The metadata may be a number of “Likes”, number of comments and the like. The metadata is displayed in the inbox level or when opening the received email message.

Step 330 discloses assigning an area to display each type of metadata for each email. It is preferred to display each type of metadata in a predefined area, whether the metadata is displayed at the inbox level or in the email itself. For example, the total number of recipients may be displayed at the top-left corner of each email for all the email messages.

Step 340 discloses determining which metadata is to be displayed for each email. In many cases, metadata is extracted which does not add any insight to the user. For example, there is only one recipient to this email. In such a case, the system may determine that there is no need to display the total number of recipients. In other cases the system may limit the number of the displayed notification to 2 for example, in order to simplify email's display.

Step 350 discloses determining if the user is the only recipient of the email message from the same domain, that is in case other recipients of the email messages have addresses of other domains. For example, a lawyer receives an email from a client in which the client Ccs two of the client's colleagues and no other person from the lawyer's firm, which is equivalent to the lawyer's domain. In many cases, if the lawyer does not respond to this email, no one from the lawyer's firm will respond and the received email that may get lost in the ocean of emails. The indication of the recipient being the sole recipient from the same domain name brings the received email to the recipient's attention.

Step 360 discloses displaying the extracted metadata on the user's display device. The extracted metadata may be displayed on the inbox level or in the email itself. The extracted metadata may be displayed as an overlay on top of the email message on the inbox level of the email client. The metadata may be displayed on a predefined area of the email on the inbox level of the email client.

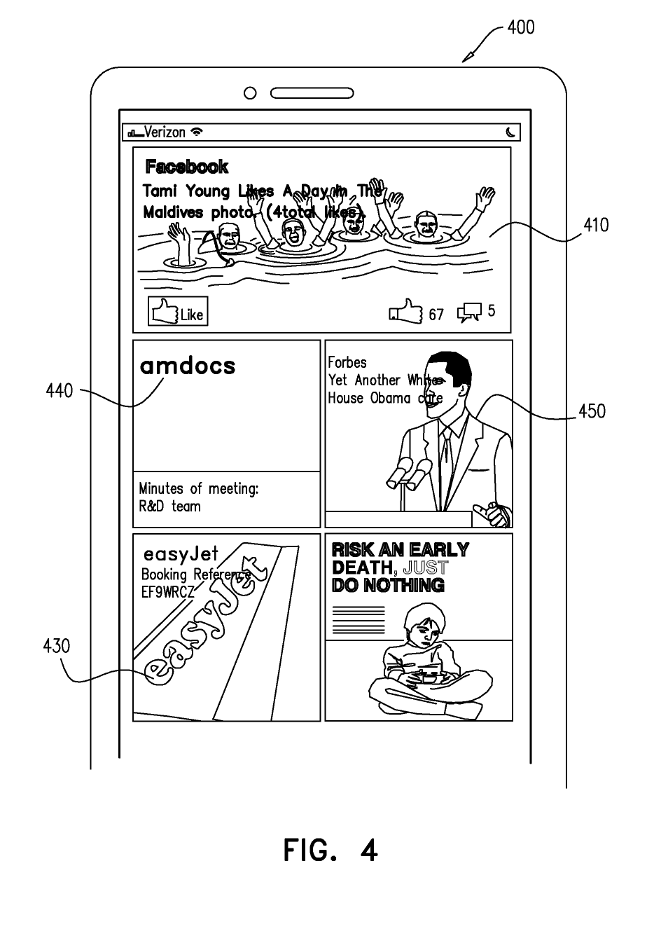

FIG. 4 shows a list of email messages displayed on an email client. The email client may be displayed on a smartphone having a display in the range of 3-6 inches. The method and system of the present invention may also be used and implemented in PCs, tablets, laptops and the like. FIG. 4 shows visual content associated with multiple email messages and displayed on the list of email messages of the email client. The visual content may be an image 410 taken from a Facebook account in case the user of the email client received an email message from Facebook that concerns the image. Such email may be in the form of “John smith tagged you in the album XYZ”. The present invention displays the image in which the recipient was tagged instead of sending the user to the Facebook web page or mobile application and saves the user time and effort. The textual information of the email may appear as an overlay on top of the image 410, in case the image 410 consumes the entire space allocated to the specific email on the list of emails 400. In some exemplary cases, the present invention provides for displaying two email messages in the same row, not a single one. In other cases, there is a single email message in a single row. The email messages of the present invention may be displayed in the chronological order of receipt.

FIG. 4 also shows an image 450 extracted from an external link in a case the user of the email client received an email in the form of “John smith just sent you an interesting link”. Instead of pressing the link from the mobile email client, the user is able to view the image 450 without accessing the email message itself. Additional data about the link, for example the media entity 455 associated with the link such as Forbes or the writer's name may appear as a layer on top of the image 450. In some other cases, the image 450 may consume a predefined percentage of the space allocated to the email in the list, and the additional data is displayed above the image.

FIG. 4 also shows an email message sent from an organization, such as Amdocs LTD 440. As standard email clients show the sender's name, in many cases the more interesting data field is the organization that the sender works in. the name of the organization 440 may be extracted from the sender's email address, as well as the logo of the organization. If the user is waiting for an email from the organization, in many cases the logo of the organization 440 is the key factor, without having to access each and every email, just from a brief review on the list of emails. The email from the organization 440 may include additional metadata that implies the importance of the email without accessing it, for example, the number of recipients. An email from the CEO is not important when sent to 500 recipients and may be crucial when sent to 2 recipients.

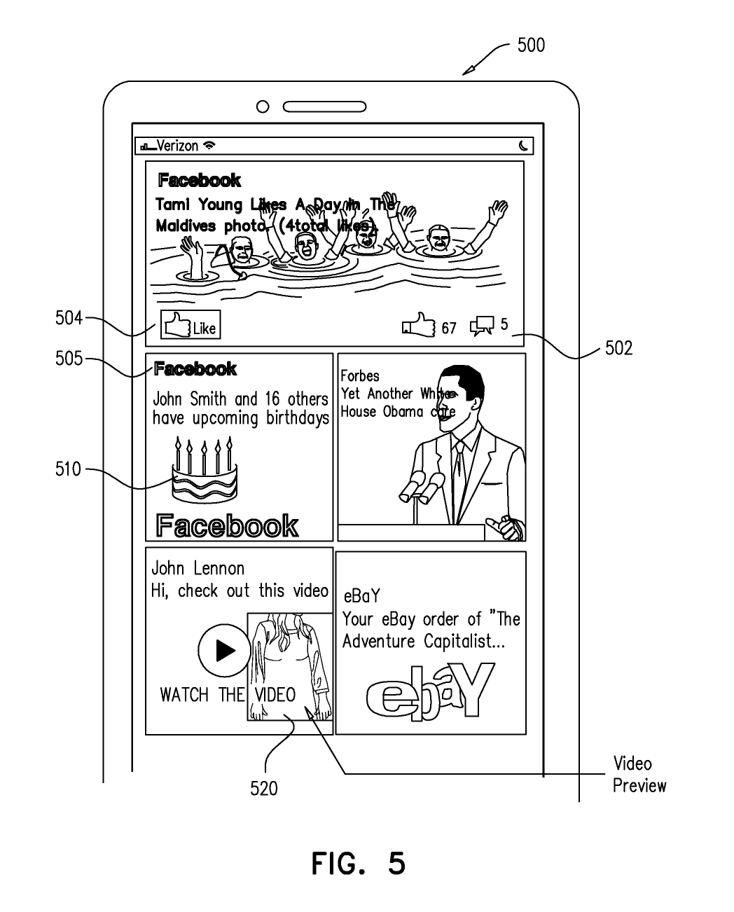

FIG. 5 shows extraction of metadata from the email and displaying the metadata of the email on the list of emails, without accessing the email itself. The metadata may be whether the recipient is on the “To” field or the CC field. The metadata 502 may relate to the number of likes that image from Facebook already received by other users. The metadata 502 may be the birthday alerts from Facebook 505, while adding a relevant image 510. Another option of the metadata 502 is a video preview 520 of an image in case the email contains a link to a video, for example to a YouTube page. The image displayed on the list of emails for each email message is selected for the specific email message. The image may be selected from predefined image storage, for example according to the context of the email, such as finance, recipe, theatre, sports, vacation or others. The image may be extracted from a link on the email. The image may be extracted according to the sender's identity.

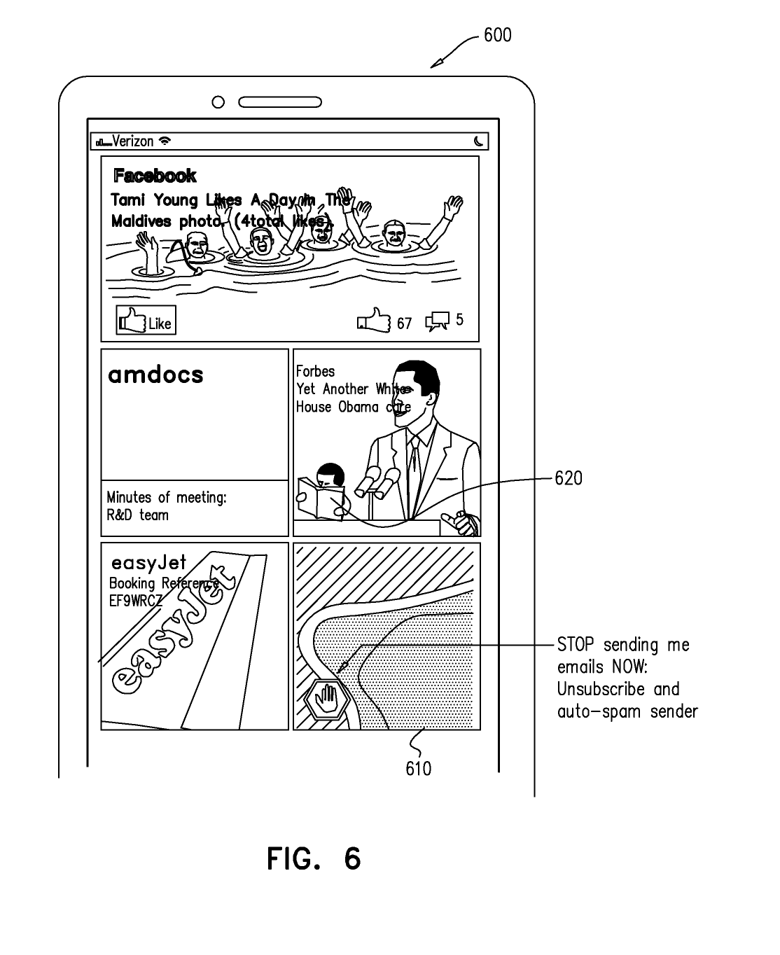

FIG. 6 shows a list of email from which the user of the email client can perform an action without accessing the email. One action can be to have an image liked, when the image is sent from Facebook. This icon enables the server to approach the user's Facebook account and perform a “like” 504 to the picture that was displayed as the email on the list of emails, instead of pressing many buttons, accessing the email itself and then access a web page or Facebook mobile application. Another action that can be performed directly from the list of emails is to block future messages 610 from a specific sender. Such icon 610 may be displayed when the server identifies that the sender is likely to be rejected or that the email is a selling email, or according to previous actions by the user, such as deleting every email from the specific sender. Another action that can be performed directly from the list of emails is to download content from a link 620 in case the link was sent from a friend and seems to be interesting. The server may copy the data from the link to the user's phone, or send the content as an additional email.

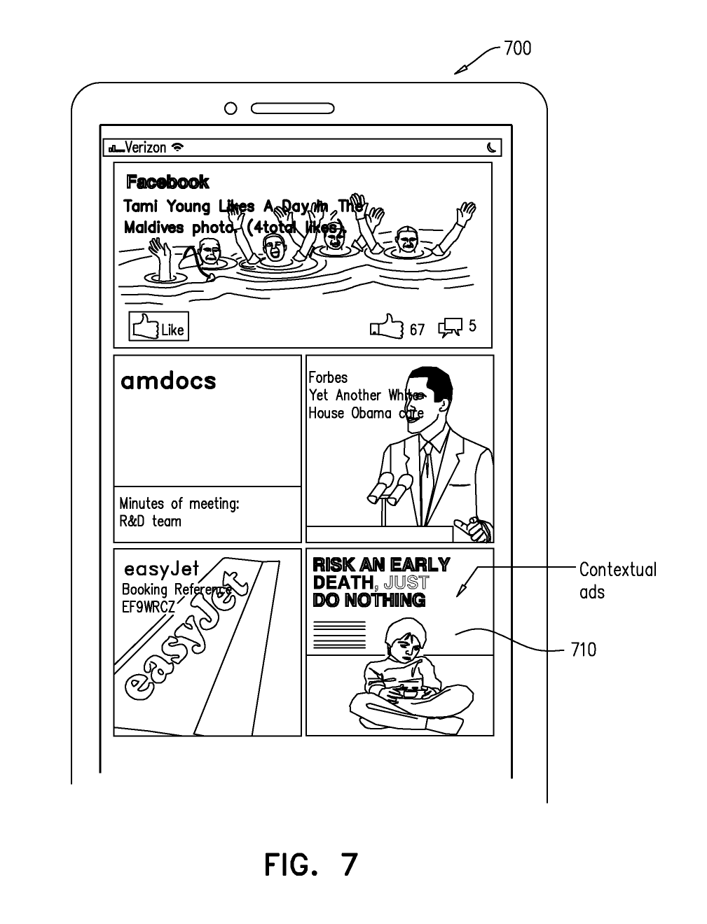

FIG. 7 shows an exemplary embodiment in which advertisement is added into the list of email messages. As the list of email messages provides a visual display of images, it is more intuitive for users of the email client to view commercial advertisements. In prior art email clients that include only textual information, it is highly unlikely to add advertisements. The location of the advertisement on the display device of the user's device may be predefined, for example the right bottom corner, while the rest of the display area is allocated to the list of emails. In such a case, the advertisement location does not change when the user rolls up and down on the list of email messages. The content of the advertisement is determined according to contextual analysis of other email on the list, or according to user's preferences and personal information, such as gender, age and place of residence.

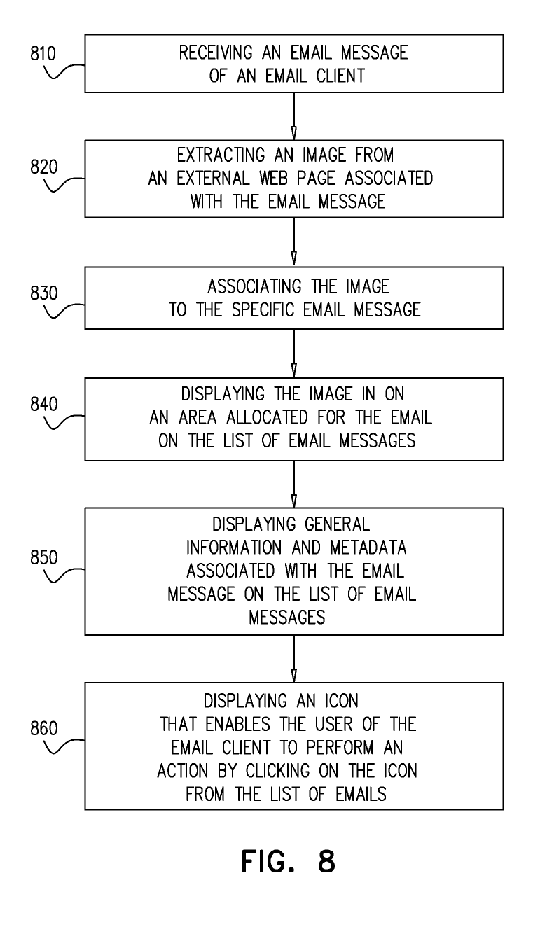

FIG. 8 shows a method for extracting data associated to a specific email message and displaying the data, according to exemplary embodiments of the subject matter. Step 810 discloses receiving an email message of an email client. The email message may also be sent to other recipients, and is passed via an email server, such as google email server or Yahoo email server. Step 820 discloses extracting an image from an external web page associated with the email message. The external web page may reside on a web server, and may be a news web page, e-commerce, social network, online data storage service and the like. In some exemplary cases, the image is extracted from a web page according to a link which is part of the received email message, such as an article sent to a friend.

Step 830 discloses associating the image to the specific email message. Step 840 discloses displaying the image in on an area allocated for the email on the list of email messages. Displaying the image on the list of email messages enables the recipient of the email message to decide whether or not the content of the email message is interesting. Further, the image provides an input on whether or not to open an external link found inside the email message. Step 850 discloses displaying general information and metadata associated with the email message on the list of email messages. The metadata may include various parameters such as number of recipients of the email, an importance icon determined by analyzing the text of the email, type of attachment of the email. Step 860 discloses displaying an icon that enables the user of the email client to perform an action by clicking on the icon from the list of emails. The action may be to block all future messages from the sender of the email message, perform an action on the image such as pressing a “Like” virtual button of the image, download content from the web page and the like.

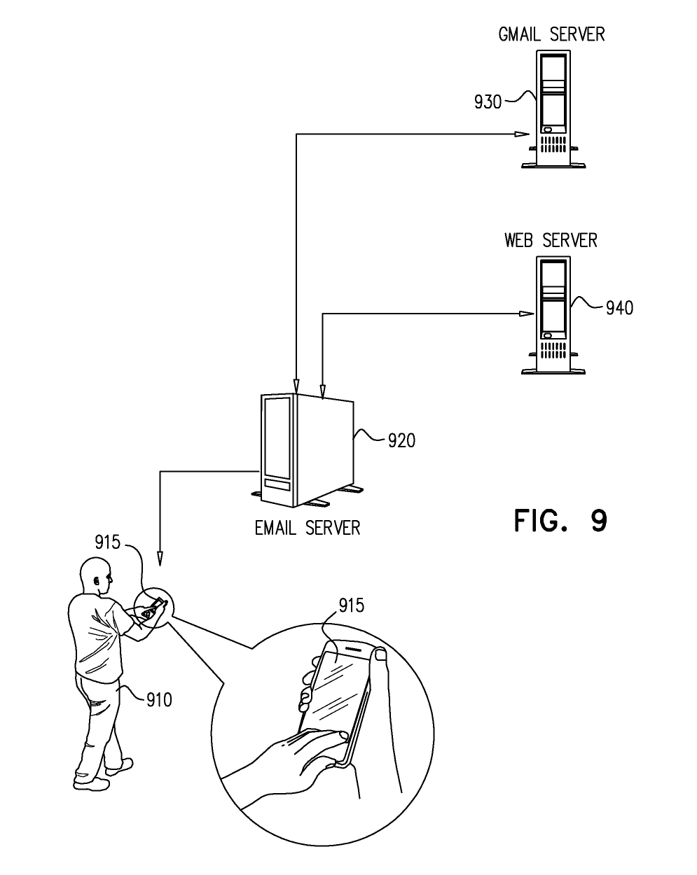

FIG. 9 shows a computerized environment for extracting data associated to a specific email message and displaying the data, according to exemplary embodiments of the subject matter. The computerized environment comprises an email server 920 that handles the email messages provided to an email client. The email client may reside on a computerized device 915 of a person 910 which is the recipient of the email messages sent via the email server 920. The email server 920 may communicate with an email server 930, such as google email server or Microsoft email server in order to receive the email messages of the recipient, analyze them and send them to the email client for display. The email server 920 may communicate with a web server 940 when one of the email messages comprises a link from which the email server 920 extracts an image. In some exemplary cases, the image may be an icon of the web page, such as an icon of CNN.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method, comprising:
receiving an email message of an email client;
extracting email attributes from the email message;
generating metadata that characterizes the received email message according to the email attributes extracted from the email message;
displaying the metadata that characterizes the received email message.

2. The method of claim 1, wherein said metadata is displayed on an inbox level of the email client.

3. The method of claim 1, wherein said metadata comprises number of total recipients of the email message and wherein said generating metadata comprises accumulating the number of recipients of the email message and displaying the number of recipients on the inbox level of the email client.

4. The method of claim 1, wherein said metadata comprises number of attachment files attached to the received email message.

5. The method of claim 4, wherein said metadata displayed on the inbox level of the email client also comprises an attachment type of the attachment files attached to the received email

6. The method of claim 1, wherein the metadata is displayed as an image on top of the email message on the inbox level of the email client.

7. The method of claim 1, wherein the metadata is displayed on a predefined area of the email on the inbox level of the email client.

8. The method of claim 1, wherein generating two or more metadata elements, each of the two or more metadata elements is associated with a different type of email attributes extracted from the received email message, said two or more metadata elements are displayed on the inbox level of the email client.

9. The method of claim 8, wherein the type of metadata is selected from a group comprising number of recipients, whether the user receiving the email was addressed in “To” or “Cc” field, number of attachments, attachment type, urgency indication and a combination thereof.

10. The method of claim 1, further comprises selecting whether or not to display the metadata for the received email message.

11. The method of claim 10, wherein selecting whether or not to display the metadata is determined by comparing the extracted email attributes to a predefined condition.

12. The method of claim 1, wherein the metadata indicates that the email client is the only email client of the email domain that receives the email.

13. The method of claim 1, wherein performed on a client side of the email client.

14. The method of claim 1, wherein the metadata that characterizes the received email message is displayed as an image.

15. The method of claim 14, further comprises selecting a specific image from an image storage according to the metadata.

16. The method of claim 1, wherein the metadata indicates a country of a sender of the received email message.

17. The method of claim 1, wherein the email message comprises a link to a web page, wherein the extracted metadata comprises an indication of the web page.

18. The method of claim 1, wherein the metadata is a number of links appearing in the received email message and wherein the number of links is displayed on the inbox level of the email client.

19. The method of claim 1, wherein the metadata is urgency indication identified from the text of the received email message.

20. A system, comprising:
an email receiver for receiving an email message of an email client;
attributes extraction unit for extracting email attributes from the email message;
metadata processing unit generating metadata that characterizes the received email message from the email attributes extracted from the email message;
wherein the generated metadata is displayed on a display device to characterize the received email message.

21. A method of displaying a list of email messages on an email client, comprising:
receiving an email message;
extracting an image from an external web page associated with the received email message;
displaying the image on an area allocated for the received email message on the list of email messages.

22. The method according to claim 21, wherein the external web page is a Facebook web page.

23. The method according to claim 21, wherein the external web page that a link inside the email directs to.

24. The method according to claim 21, wherein the external web page is a web page owned by an organization that has the domain of the sender.

25. The method according to claim 21, further comprises displaying general information of the email.

26. The method according to claim 25, wherein the general information comprises sender's name, date of receipt of email, subject.

27. The method according to claim 21, further comprises displaying metadata of the email.

28. The method according to claim 27, wherein the metadata comprises number of recipients of the email, an importance icon determined by analyzing the text of the received email message, type of attachment of the email.

29. The method according to claim 21, wherein the image consumes a portion of the space allocated to the received email message on the list of email messages.

30. The method according to claim 21, further comprises displaying an icon that enables the user of the email client to perform an action by clicking on the icon from the list of email messages.

31. The method according to claim 30, wherein the action is to block all messages from the sender.

32. The method according to claim 30, wherein the action is to “like” an image.

33. The method according to claim 30, wherein the action is to download an article from a web page to the user's device.
